(19) United States
(12) Patent Application Publication
(10) Pub. No.: US 2010/0195188 A1
(43) Pub. Date: Aug. 5, 2010

(54) ELECTROPHORETIC DISPLAY PANEL AND ELECTROPHORETIC DISPLAY APPARATUS

(75) Inventors: Chun-Ming Huang, Taichung County (TW); Po-Hsien Wang, Taichung City (TW); Chih-Chang Lai, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/699,042

(22) Filed: Feb. 3, 2010

(30) Foreign Application Priority Data
Feb. 5, 2009 (TW) 98103671

(51) Int. Cl. G02F 1/167

(52) U.S. Cl. 359/296

(57) ABSTRACT

An electrophoretic display panel includes a transparent substrate, a first electrode, a transparent wall, a plurality of display media, and a plurality of reflective elements. The first electrode is disposed on the transparent substrate. The transparent wall is disposed on the first electrode to define a plurality of micro-cell structures on the first electrode. Each of the micro-cell structures is respectively filled with the display media, and each of the display media has a plurality of colored particles. Each of the reflective elements is disposed on a projection direction of the transparent wall on the transparent substrate. An electrophoretic display apparatus is also provided. The electrophoretic display panel and the electrophoretic display apparatus can be used on condition of various illuminations and have advantages of maintaining display brightness and ensuring low power consumption.

### CROSS-REFERENCE TO RELATED APPLICATION

This application claims the priority benefit of Taiwan application serial no. 98103671, filed on Feb. 5, 2009. The entirety of the above-mentioned patent application is hereby incorporated by reference herein and made a part of specification.

### BACKGROUND OF THE INVENTION

1. Field of the Invention

The present invention relates to a display panel and a display apparatus. More particularly, the present invention relates to an electrophoretic display panel and an electrophoretic display apparatus.

2. Description of Related Art

With the development of flat panel displays, manufacturers aim at equipping future displays with features including lightness, thinness, and flexibility. Among the displays, an electrophoretic display has attracted great attention.

A method of fabricating a conventional electrophoretic display apparatus includes first forming a transparent electrode layer and a wall structure on a substrate to define a plurality of micro-cell structures and then filling display media into the micro-cell structures to form a plurality of display unit cells. The display media have black fluids and a plurality of white particles. Next, a passivation layer and an adhesive layer are sequentially formed on top of the micro-cell structures, and an active device array substrate is disposed on one side of the adhesive layer opposite to the passivation layer, such that the two substrates are bonded together. When an electric field between the transparent electrode layer and each pixel electrode of the active device array substrate is changed, the white particles move upward or downward upon a direction of the electric field, and regions corresponding to pixels respectively display the black color or the white color.

The aforesaid electrophoretic display apparatus frequently adopts a front light or an external light as a light source whereby a user is able to observe the black display region or the white display region. Nonetheless, when the electrophoretic display apparatus is employed indoors and is supplied with insufficient light, it is not apt for the user to identify images displayed by the electrophoretic display apparatus. On the contrary, there is no such problem when a reflective liquid crystal display is utilized in an outdoor environment, and the reflective liquid crystal display herein does not require a backlight source. Under said circumstances, the electrophoretic display apparatus consumes unnecessary electric power. It can be learned from the above that the conventional electrophoretic display apparatus is not likely to be used on the condition of every type of illumination. Therefore, before the electrophoretic display apparatus is extensively applied, manufacturers yearn to resolve issues of the electrophoretic display apparatus as to well design an internal structure of the electrophoretic display apparatus for maintaining display luminance in indoor use and for ensuring low power consumption in outdoor use.

### SUMMARY OF THE INVENTION

The present invention is directed to an electrophoretic display panel that is able to maintain display luminance when the electrophoretic display panel is used on the condition of various illuminations.

The present invention is further directed to an electrophoretic display apparatus that is able to modulate intensity of light from a backlight source based on an ambient light. Thereby, the electrophoretic display apparatus is characterized with favorable display quality and low power consumption.

In the present invention, an electrophoretic display panel including a transparent substrate, a first electrode, a transparent wall, a plurality of display media, and a plurality of reflective elements is provided. The first electrode is located on the transparent substrate. The transparent wall is disposed on the first electrode to define a plurality of micro-cell structures on the first electrode. Each of the micro-cell structures is respectively filled with the display media, and each of the display media has a plurality of colored particles. Each of the reflective elements is disposed on a projection direction of the transparent wall on the transparent substrate.

According to an embodiment of the present invention, the electrophoretic display panel further includes a backlight source, and the display media are located between the transparent substrate and the backlight source.

According to an embodiment of the present invention, each of the display media includes a fluid and the colored particles. Here, the fluids of the display media respectively have different colors.

According to an embodiment of the present invention, the transparent substrate is, for example, a flexible substrate.

In the present invention, an electrophoretic display apparatus including an electrophoretic display panel, an active device array substrate, a backlight source, and a photo sensor is further provided. The electrophoretic display panel includes a transparent substrate, a transparent wall, a first electrode, a plurality of display media, and a plurality of reflective elements. The transparent wall is located on the transparent substrate to define a plurality of micro-cell structures on the transparent substrate. The first electrode is located between the transparent substrate and the transparent wall. Each of the micro-cell structures is respectively filled with the display media, and each of the display media has a plurality of colored particles. Each of the reflective elements is located on a projection direction of the transparent wall on the transparent substrate and located between the transparent substrate and the transparent wall. The active device array substrate has a plurality of second electrodes. The display media are located between the second electrodes and the first electrode. The active device array substrate is located between the electrophoretic display panel and the backlight source. The reflective elements are located on a moving path of a light from the backlight source. The photo sensor is electrically connected to the backlight source. Besides, the photo sensor is adapted to sense an incident ambient light input from one side of the electrophoretic display panel and modulate intensity of the light from the backlight source.

Since the electrophoretic display panel of the present invention possesses the reflective elements capable of reflecting light backing against the ambient light, the electrophoretic display panel of the present invention can make use of the light backing against the ambient light to maintain the display luminance when the intensity of the ambient light is reduced. Moreover, the electrophoretic display apparatus of the present invention is further equipped with the photo sensor capable of modulating intensity of the light from the backlight source, and the electrophoretic display apparatus can be used on the condition of various illuminations when the photo sensor is employed in company with the reflective elements. Thereby, images displayed by the electrophoretic display apparatus have satisfactory quality, and a power-saving function can also be achieved by using the electrophoretic display apparatus of the present invention.

To make the above and other features and advantages of the present invention more comprehensible, several embodiments accompanied with figures are detailed as follows.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic cross-sectional view of an electrophoretic display panel according to a first embodiment of the present invention.

FIG. 2 is a schematic cross-sectional view of an electrophoretic display panel according to another embodiment of the present invention.

FIGS. 3 and 4 are schematic cross-sectional views of an electrophoretic display apparatus according to a second embodiment of the present invention.

### DESCRIPTION OF EMBODIMENTS

### First Embodiment

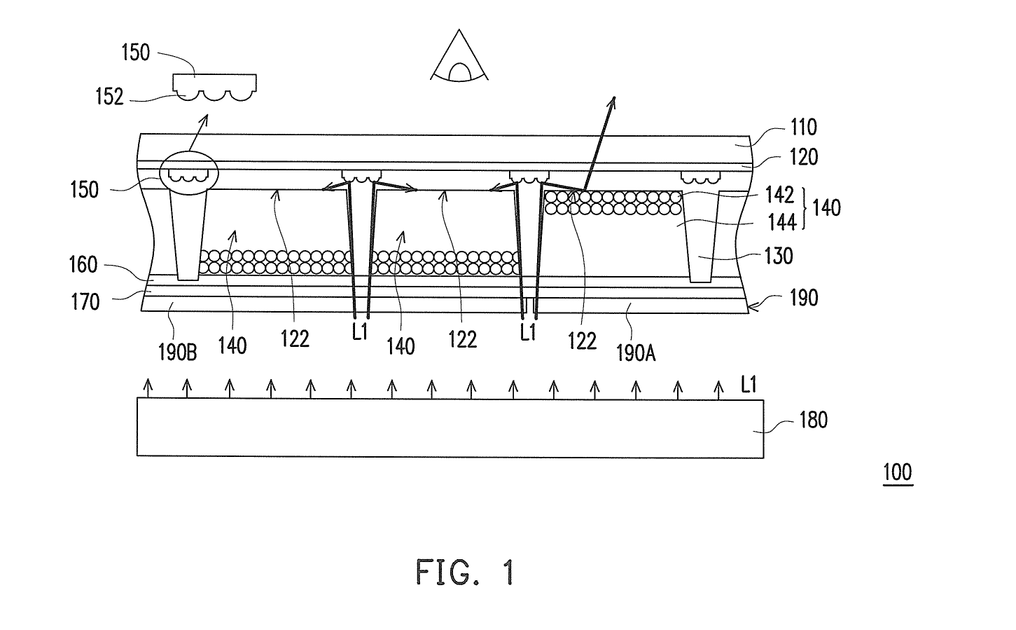

FIG. 1 is a schematic cross-sectional view of an electrophoretic display panel according to a first embodiment of the present invention. Referring to FIG. 1, the electrophoretic display panel 100 of the present embodiment mainly includes a transparent substrate 110, a first electrode 120, a transparent wall 130, a plurality of display media 140, and a plurality of reflective elements 150. Here, the transparent substrate 110 is, for example, a flexible substrate, which should not be construed as a limitation of the present invention. The first electrode 120 is located on the transparent substrate 110. The transparent wall 130 is located on the first electrode 120, so as to define a plurality of micro-cell structures 122 on the first electrode 120. Here, the micro-cell structures 122 are arranged in array, for example. Each of the micro-cell structures 122 is filled with the display media 140, respectively, and each of the display media 140 has a plurality of colored particles 142. The movement of the colored particles 142 is determined upon a direction at which an electric field is applied to the colored particles 142, and regions corresponding to the display media 140 then display different colors. Each of the reflective elements 150 is located on a projection direction of the transparent wall 130 on the transparent substrate 110. As shown in FIG. 1, on the transparent wall 130 and the display media 140, the electrophoretic display panel 100 can selectively cover a passivation layer 160 and an adhesive layer 170.

Note that the reflective elements 150 of the present embodiment are located between the transparent wall 130 and the first electrode 120, for example. Certainly, the reflective elements 150 can also be positioned between the transparent substrate 110 and the first electrode 120. The positions of the reflective elements 150 in the electrophoretic display panel 100 in a cross-sectional direction are not restricted in the present invention. Upon different kinds of products and manufacturing processes, the reflective elements 150 are determined to be disposed in any film layer on the projection direction of the transparent wall 130. Moreover, each of the reflective elements 150 is located on the projection direction of the transparent wall 130 on the transparent substrate 110. Therefore, the reflective elements 150 of the present invention are adapted to use an incident light L1 input from a side opposite to the transparent substrate 110 and reflect the incident light L1 onto the display media 140 adjacent to the transparent substrate 110. As such, the incident light L1 from a back side of the electrophoretic display panel 100 can be transmitted along a direction from the transparent wall 130 and the reflective elements 150 to the transparent substrate 110. In addition, images observed by a user from the transparent substrate 110 can have enhanced brightness when the ambient light is relatively insufficient.

As indicated in FIG. 1, designers can, upon actual demands for various products, further dispose a backlight source 180 at a side opposite to the display media 140 that are located on the transparent substrate 110, such that the display media 140 are located between the transparent substrate 110 and the backlight source 180. Thereby, the incident light L1 supplied by the backlight source 180 can be used by the reflective elements 150 of the present invention, and the reflected light L1 can be projected onto the display media 140, so as to increase brightness of the images which are observed by the user. In other words, when the electrophoretic display panel 100 is used in an indoor environment with insufficient illumination, the display media 140 can display images with constant luminance by means of the incident light L1 reflected by the reflective elements 150. As such, notwithstanding the restricted ambient light, the issue regarding insufficient luminance of the images can be successfully resolved.

Besides, the display media 140 located on the transparent substrate 110 and arranged in array are driven by the first electrode 120 and different second electrodes, such that the colored particles 142 of the display media 140 can identify images with favorable indices of identification on the condition of distinct voltage differences. To be more specific, the display media 140 are located between the first electrode 120 and the second electrodes 190, and each of the display media 140 is constituted by the colored particles 142 and a fluid 144 having different colors, such as white particles and a black fluid. As shown in FIG. 1, the micro-cell structures 122 are filled with the fluid 144, and the colored particles 142 are distributed in the fluid 144. When a voltage difference exists between the second electrodes 190 and the first electrode 120, the colored particles 142 move relative to the fluid 144 in accordance with the direction at which the electric field is applied to the colored particles 142, such that the colored particles 142 of each of the display media 140 adjacent to the transparent substrate 110 are changed in number, and that each of the display media 140 displays the black color or the white color.

For instance, the electric filed generated by the first electrode 120 and the second electrode 190A located on the right side in FIG. 1 faces toward a direction of the first electrode 120, and therefore the colored particles 142 of the display media 140 corresponding to the second electrode 190A are positioned at a side of the fluid 144 adjacent to the first electrode 120. As such, white images are displayed. Likewise, in the present embodiment, the electric filed generated by the first electrode 120 and the second electrode 190B located on the left side in FIG. 1 faces toward a direction of the second electrode 190B, and therefore the colored particles 142 of the display media 140 (located at the left side and the center in FIG. 1) corresponding to the second electrode 190B are positioned at a side of the fluid 144 adjacent to the second electrode 190B. As such, black images are displayed.

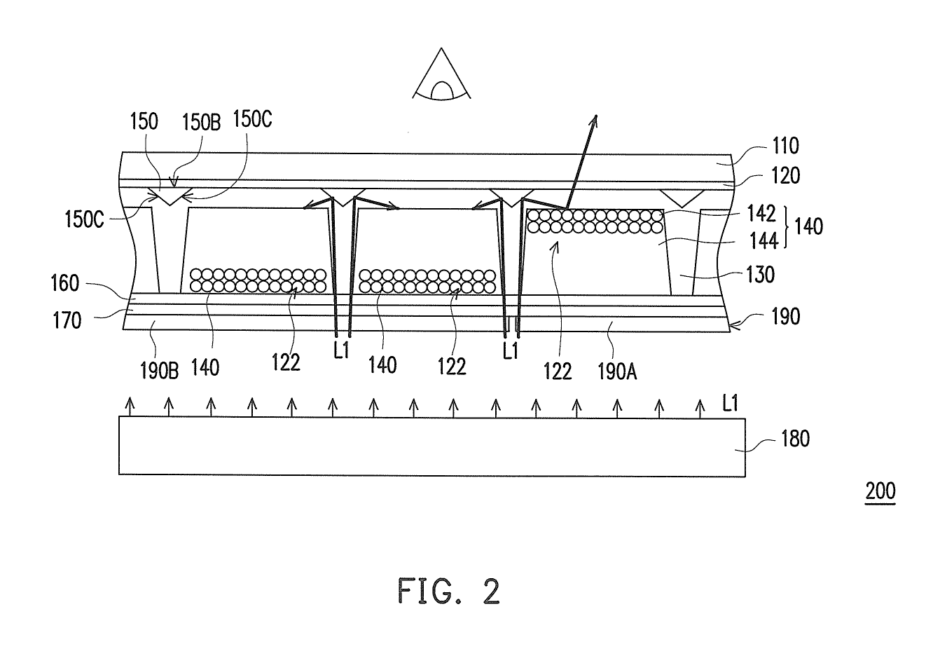

In the aforesaid examples, a plurality of protrusions 152 are, for example, disposed on a side of the reflective elements 150 facing the passivation layer 160. The protrusions 152 serve to assist the reflective elements 150 in reflecting the incident light L1. FIG. 2 is a schematic cross-sectional view of an electrophoretic display panel according to another embodiment of the present invention. Referring to FIG. 2, the reflective elements 150 in the electrophoretic display panel 200 of the present embodiment can have a pyramid shape, such as a triangular pyramid as shown in FIG. 2. Here, a bottom surface 150B of the pyramid adjoins the transparent substrate 110, and at least one of side surfaces 150C of the pyramid substantially faces the display media 140. As shown in FIG. 2, two side surfaces 150C of pyramid substantially face to the display media 140 in this cross-sectional view. Thereby, the side surfaces 150C of the pyramid facing the display media 140 are conducive to improving a rate of utilizing the incident light L1 from an available light source. Note that pyramids with appropriate shapes can be chosen by referring to a distance from the reflective elements 150 to the display media 140 and the number of the adjacent display media 140, and tilt angles between the side surfaces 150C of the pyramid and the bottom surface 150B of the pyramid can be properly adjusted.

It is certain that the reflective elements 150 can also have a cone shape in other embodiments, and a bottom surface of the cone adjoins the transparent substrate 110. A side surface of the cone substantially faces the display media 140. In the present invention, the shape of the reflective elements 150 is not limited. Moreover, in practice, a material of the reflective elements 150 can be selected from materials having a high reflection coefficient. In terms of metallic materials, chromium, aluminum, silver, an alloy thereof, or other metallic materials can be used. Undoubtedly, the reflective elements 150 can also be made of other materials characterized by a high reflection coefficient, which should not be construed as limited to the present invention.

### Second Embodiment

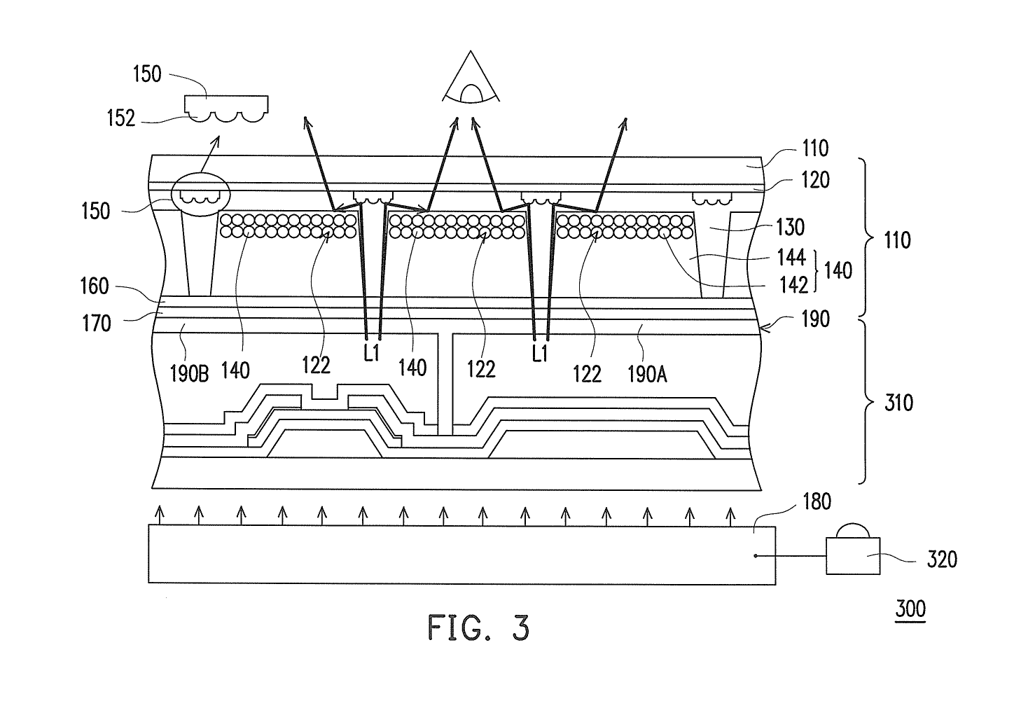

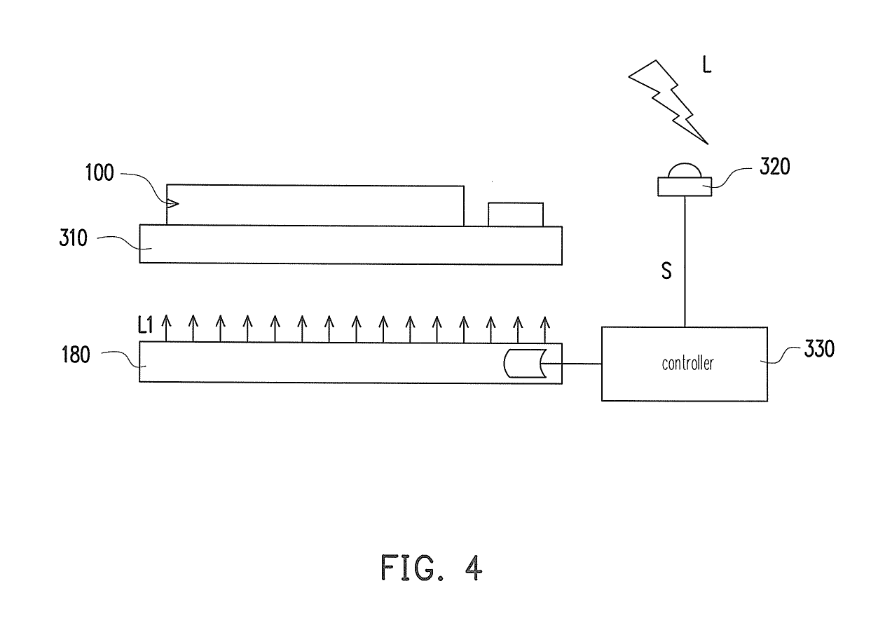

FIGS. 3 and 4 are schematic cross-sectional views of an electrophoretic display apparatus according to a second embodiment of the present invention. Referring to FIGS. 3 and 4, the electrophoretic display apparatus 300 of the present embodiment serves as an application of the electrophoretic display panels 100 and 200 (as shown in FIGS. 1 and 2) in the first embodiment. In comparison with the first embodiment, the present embodiment discloses the electrophoretic display apparatus 300 including an active device array substrate 310, the backlight source 180, and a photo sensor 320. The active device array substrate 310 is located between the electrophoretic display panel 100 and the backlight source 180. The reflective elements 150 are located on a moving path of a light L1 from the backlight source 180. Besides, the photo sensor 320 is, for example, electrically connected to the backlight source 180 through a controller 330. Additionally, the photo sensor 320 is adapted to sense an ambient light L input from one side of the electrophoretic display panel 100 and modulate the intensity of the light L1 from the backlight source 180.

Specifically, the photo sensor 320 is, for example, disposed at a side adjacent to the transparent substrate 110 for detecting the ambient light L input from one side of the electrophoretic display panel 100, such that the electrophoretic display apparatus 300 can respectively modulate the light intensity of the backlight source 180, display images with constant luminance, and accomplish a power-saving function. In detail, when the electrophoretic display apparatus 300 is used in an outdoor environment or with sufficient illuminations, the electrophoretic display apparatus 300 can fully make use of the ambient light L as a light source by which images can be observed. Here, the photo sensor 320 can input sensing signals S into the controller 330, and the controller 330 then modulates the light intensity of the backlight source 180. Namely, the backlight source 180 is in a power-saving mode, and the intensity of the light L1 is reduced. By contrast, when the electrophoretic display apparatus 300 is used in an indoor environment or with relatively insufficient illuminations, the available ambient light L is restricted, and the sensing signals S can be fed back to the backlight source 180 by the photo sensor 320 for enhancing the light intensity of the backlight source 180. The light L1 supplied by the backlight source 180 is reflected by the reflective elements 150 onto the display media 140 and is projected to eyes of the user. Hence, notwithstanding the insufficient ambient light L, the images having constant luminance can still be observed.

In the above-mentioned examples, the active device array substrate 310 has a plurality of pixels arranged in array, and each of the pixels has corresponding a pixel electrode. According to the present embodiment, the pixel electrode serves as the second electrode 190 of the first embodiment and is used to generate voltage difference between the pixel electrode and the first electrode 120. Thereby, the display media 140 corresponding to the pixel electrode can achieve display effects having different colors and chrominance by way of distinct voltage differences. However, the structure of the active device array substrate 310 is not limited to what is disclosed above. That is to say, the active device array substrate 310 and the backlight source 180 in the electrophoretic display can also be replaced by a self-luminous organic electro-luminescence array substrate, so as to obtain a display apparatus with a reduced thickness.

In summary, the electrophoretic display panel and the electrophoretic display apparatus provided in the present invention have at least the following advantages:

1. The electrophoretic display panel of the present invention has the reflective elements capable of reflecting light which backs against the ambient light. Hence, the electrophoretic display panel of the present invention can make use of the light backing against the ambient light to maintain the display luminance when the intensity of the ambient light is reduced.

2. The electrophoretic display apparatus of the present invention is equipped with the photo sensor capable of sensing the ambient light and the reflective elements capable of using the light from the backlight source. Therefore, the electrophoretic display apparatus of the present invention can reduce the light intensity of the backlight source when the electrophoretic display apparatus is used in an outdoor environment or with sufficient illuminations. Moreover, the power-saving function can also be accomplished. Further, when the electrophoretic display apparatus is used in an indoor environment or with relatively insufficient illuminations, the reflective elements serve to fully make use of the light from the backlight source, and variations in luminance due to the changing intensity of the ambient light can be decreased. As such, favorable display quality can be ensured.

Although the present invention has been disclosed by the above embodiments, they are not intended to limit the present invention. Anybody skilled in the art may make some modifications and alterations without departing from the spirit and scope of the present invention. Therefore, the protection range of the present invention falls in the appended claims.

What is claimed is:

1. An electrophoretic display panel, comprising:
a transparent substrate;
a first electrode disposed on the transparent substrate;
a transparent wall disposed on the first electrode to define a plurality of micro-cell structures on the first electrode;
a plurality of display media respectively filling each of the micro-cell structures, each of the display media having a plurality of colored particles; and
a plurality of reflective elements, wherein each of the reflective elements is located on a projection direction of the transparent wall on the transparent substrate.

2. The electrophoretic display panel as claimed in claim 1, further comprising a passivation layer covering the transparent wall and the display media.

3. The electrophoretic display panel as claimed in claim 1, wherein the reflective elements are located between the transparent wall and the first electrode.

4. The electrophoretic display panel as claimed in claim 1, further comprising a plurality of second electrodes, wherein the display media are located between the first electrode and the second electrodes, and the colored particles move relative to each of the display media corresponding thereto when a voltage difference exists between the second electrodes and the first electrode, such that the colored particles of each of the display media adjacent to the transparent substrate are changed in number.

5. The electrophoretic display panel as claimed in claim 1, further comprising a backlight source, the display media being located between the transparent substrate and the backlight source.

6. The electrophoretic display panel as claimed in claim 1, wherein each of the display media comprises a fluid and the colored particles.

7. The electrophoretic display panel as claimed in claim 6, wherein the fluids of the display media respectively have different colors.

8. The electrophoretic display panel as claimed in claim 1, a plurality of protrusions being located on one side of the reflective elements facing the passivation layer.

9. The electrophoretic display panel as claimed in claim 1, wherein a shape of the reflective elements comprises a pyramid, a bottom surface of the pyramid adjoins the transparent substrate, and at least one of side surfaces of the pyramid substantially faces the display media.

10. The electrophoretic display panel as claimed in claim 1, wherein a shape of the reflective elements comprises a cone, a bottom surface of the cone adjoins the transparent substrate, and a side surface of the cone substantially faces the display media.

11. The electrophoretic display panel as claimed in claim 1, wherein a material of the reflective elements comprises chromium, aluminum, silver, or an alloy thereof.

12. The electrophoretic display panel as claimed in claim 1, wherein the transparent substrate is a flexible substrate.

13. An electrophoretic display apparatus, comprising:
an electrophoretic display panel, comprising:
a transparent substrate;
a transparent wall disposed on the transparent substrate to define a plurality of micro-cell structures on the transparent substrate;
a first electrode located between the transparent substrate and the transparent wall;
a plurality of display media respectively filling each of the micro-cell structures, each of the display media having a plurality of colored particles;
a plurality of reflective elements, wherein each of the reflective elements is located on a projection direction of the transparent wall on the transparent substrate and located between the transparent wall and the transparent substrate;
an active device array substrate having a plurality of second electrodes, the display media being located between the second electrodes and the first electrode;
a backlight source, wherein the active device array substrate is located between the electrophoretic display panel and the backlight source, and the reflective elements are located on a moving path of a light from the backlight source; and
a photo sensor electrically connected to the backlight source, the photo sensor being adapted to sense an incident ambient light input from one side of the electrophoretic display panel and modulate intensity of the light from the backlight source.

14. The electrophoretic display apparatus as claimed in claim 13, further comprising a passivation layer located between the second electrodes and the first electrode.
